(19) United States
(12) Patent Application Publication
(10) Pub. No.: US 2007/0143341 A1
(43) Pub. Date: Jun. 21, 2007

(54) Using a memory device in a kiosk

(75) Inventors: Bill Brownell, Woodinville, WA (US); Dwain Scott Jacobsen, Issaquah, WA (US); Jaymi Cara Bauer, Bellevue, WA (US); Yonathan A. Nuta, Seattle, WA (US); Erich Michael Pleny, Redmond, WA (US)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 11/305,181

(22) Filed: Dec. 15, 2005

(51) Int. Cl. G06F 17/00

(52) U.S. Cl. 707/104.1

(57) ABSTRACT

A publicly accessible memory interface is provided in a kiosk system. The kiosk system may include various types of information, such as game related content, that may be made available to a user of the kiosk system. The publicly accessible memory interface typically allows the user to download the information onto a portable memory interface that may be compatible with the memory interface. The user may then take the portable memory device home and upload the information to a home system.

### BACKGROUND

Kiosks are commonly used to provide information to a target audience regarding a product, service, or event. Kiosks are placed in malls, shopping centers, stores or any location that an organization or business entity deems desirable. The kiosk may simply consist of a booth at which pre-printed materials are made available. In addition, the kiosk may be staffed by a salesperson or any other individual who can interact with the target audience and answer questions. However, as technological capabilities have expanded and become more cost-effective, organizations are increasingly turning to computerized kiosks or public access terminals in order to improve the interactive experience with their target audience.

Game kiosks, in particular, provide current or potential customers a highly interactive experience in which to evaluate a particular game system and/or game application, for example. The kiosks typically have pre-loaded game software that may include a single game or various games that may be selected by the user. Game kiosks are an effective form of advertising because the user is given the opportunity to fully experience a game system and/or game application while, at the same time, being proximally located to the point of sale.

The effectiveness of a game kiosk as an advertising tool often is related to the level of user interactivity that the kiosk provides. A higher level of interactivity typically improves the user's experience, which in turn may positively influence the user's purchasing decision. Often, pre-loaded software may limit the selection of games a kiosk user may play. In addition, kiosk users typically do not have a means for removing and/or retaining content that is made available on the game kiosk once they leave the kiosk. This may be a function of the game kiosk hardware, software, or both.

### SUMMARY OF THE INVENTION

The present invention is directed to downloading information, such as game related content, from a kiosk system. A publicly accessible memory interface is provided in the kiosk system, which allows a user to download information that is made available on the system. For example, the information may be downloaded onto a portable memory device that is configured to read and store information from the game kiosk system via the publicly accessible memory interface.

### BRIEF DESCRIPTION OF THE DRAWINGS

The foregoing summary, as well as the following detailed description of preferred embodiments, is better understood when read in conjunction with the appended drawings. For the purpose of illustrating the invention, there is shown in the drawings exemplary constructions of the invention; however, the invention is not limited to the specific methods and instrumentalities disclosed. In the drawings:

FIG. 1 is an illustration of a kiosk system; and

FIG. 2 is an illustration of an implementation of a kiosk system.

### DETAILED DESCRIPTION OF ILLUSTRATIVE EMBODIMENTS

The inventive subject matter is described with specificity to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the term “step” may be used herein to connote different elements of methods employed, the term should not be interpreted as implying any particular order among or between various steps herein disclosed unless and except when the order of individual steps is explicitly described.

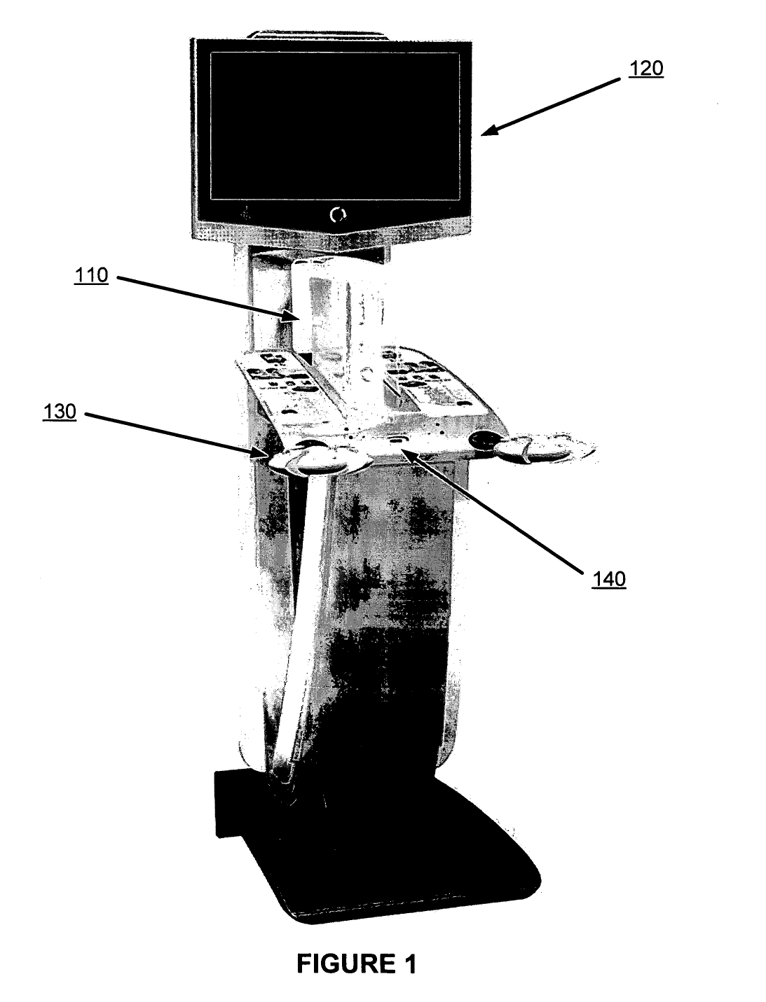

FIG. 1 is an illustration of game kiosk system 100, which may include game console 110, display 120, input device 130 and memory interface 140. Numerous other general purpose or special purpose computing terminals, systems, and/or configurations may be used. Examples include, but are not limited to, personal computers, server computers, hand-held or laptop devices, multiprocessor systems, microprocessor-based systems, set top boxes, programmable consumer electronics, network PCs, minicomputers, mainframe computers and the like.

Components of game console 110 may include, but are not limited to, a processing device (not shown), a system memory (not shown), and a system bus (not shown) that couples various system components including the system memory to the processing device. The processor device may include any appropriate processor capable of executing content, including game related content, such as a Xbox® processor. The system bus may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

The system memory may include computer storage media in the form of volatile and/or nonvolatile memory such as read only memory (ROM) and random access memory (RAM). A basic input/output system (BIOS), containing the basic routines that help to transfer information between elements within game console 110, such as during start-up, is typically stored in ROM. RAM typically contains data and/or program modules that are immediately accessible to and/or presently being operated on by the processing device.

A user may enter commands and information into game console 110 through input device 130. By way of example, and not limitation, input device 130 may include a keyboard and pointing device, such as a mouse, trackball or touch pad. Other input devices may include a microphone, joystick, game pad, game controller, satellite dish, voice command, scanner and the like. These and other input devices are often connected to game console 110 through a user input interface (not shown) that is coupled to the system bus, but may be connected by other interface and bus structures, such as a parallel port, game port or a universal serial bus (USB).

Display 120 or other type of display device is also connected to the system bus via an interface, such as a video interface (not shown), which may in turn communicate with a video memory (not shown). Display 120 may include any appropriate display device for rendering video, images and/or text. For example, display 120 may include a liquid crystal display (LCD), a plasma display, a cathode ray tube (CRT), a light emitting diode (LED) display and the like. In addition to display 120, game console 110 may also include other peripheral devices such as an audio output device (e.g., speakers), which may be connected through an output peripheral interface.

Memory interface 140 may include any appropriate interface, or a number of interfaces, for downloading information. For example, memory interface 140 may include a wireless interface (e.g., RF, optical, cellular, Wi-Fi, Wi-Max, etc.), a wired interface (e.g., hard-wired, docking station, USB compatible), or any combination thereof. In an exemplary embodiment, memory interface 140 comprises a USB compatible port for coupling to a portable memory device (not shown), such as a flash memory device.

Memory interface 140 may be made publicly accessible to any user of game kiosk system 100. Memory interface 140 may be located on game kiosk system 100 in any manner that enables the user to physically and publicly connect a portable memory device to the memory interface and download information, such as game related content. By way of example, and not limitation, memory interface 140 may be located at the front of the kiosk, proximal to input device 130, to allow the user to both interact with game kiosk system 100 and conveniently download any information that is made available to the user.

Game console 110 may also include a variety of computer readable media. Computer readable media can be any available media that can be accessed by game console 110 and includes both volatile and nonvolatile media, removable and non-removable media. By way of example, and not limitation, computer readable media may comprise computer storage media and communication media. Computer storage media may include both volatile and nonvolatile, removable and non-removable media implemented in any method or technology for storage of information such as computer readable instructions, data structures, program modules or other data. Computer storage media include, but are not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by game console 110.

Communication media typically embody computer readable instructions, data structures, program modules or other data in a modulated data signal such as a carrier wave or other transport mechanism and include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared and other wireless media. Combinations of any of the above should also be included within the scope of computer readable media.

Game console 110 may also include other removable/non-removable, volatile/nonvolatile computer storage media. By way of example only, game console 110 may have a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk, such as a CD-RW, DVD-RW or other optical media. Other removable/non-removable, volatile/nonvolatile computer storage media that can be used with game console 110 include, but are not limited to, magnetic tape cassettes, flash memory cards, digital versatile disks, digital video tape, solid state RAM, solid state ROM and the like. The hard disk drive is typically connected to the system bus through a non-removable memory interface, and a magnetic disk drive and a optical disk drive are typically connected to the system bus by a removable memory interface.

Game kiosk system 100 may operate in a networked or distributed environment using logical connections to one or more remote computers. A remote computer may be a personal computer, a server, a router, a network PC, a peer device or other common network node. The logical connections may include a local area network (LAN) and a wide area network (WAN), but may also include other networks/buses. The network connection may be made via wireline or wireless systems. Such networking environments are commonplace in homes, offices, enterprise-wide computer networks, intranets and the Internet.

When used in a LAN networking environment, game kiosk system 100 may be connected to the LAN through a network interface or adapter. When used in a WAN networking environment, game kiosk system 100 typically includes a modem or other means for establishing communications over the WAN, such as the Internet. The modem, which may be internal or external, may be connected to the system bus via the user input interface, or other appropriate mechanism. In a networked environment, program modules associated with game kiosk system 100, or portions thereof, may be stored in the remote memory storage device. It will be appreciated that other means of establishing a communications link may be used.

Game kiosk system 100 may include various types of information such as media files and/or data files. Media files may include audio-based content (e.g., MPEG layer 3 (MP3), Windows Media Audio (WMA), Waveform Audio (WAV), etc.), video-based content (e.g., MPG, MPEG, Windows Media Video (WMV), etc.) and/or image-based content (e.g., JPEG, GIF, TIFF, etc.). A user may use input device 130 to select specific audio and/or visual-based content, for example, and have it played on game kiosk system 100. Memory interface 140 may enable the user to download information, such as a media file, onto a portable memory device (not shown). The portable memory device may include an application for accessing and/or playing the media file. Thus, the user may use the portable memory device to play the media and/or transfer the media file to another device, such as a personal computer, MP3 player, personal digital assistant (PDA) and the like.

Game kiosk system 100 may also include game related content such as images for a user interface display, game applications and/or game application features (e.g., game data and visual, audio and/or functional elements associated with a game application). A user of game kiosk system 100 may use input device 130 to select and play a game application, change the visual and/or audio characteristics of the game application and/or acquire functional capabilities within the game application. Memory interface 140 may enable the user to download the game related content to a portable memory device and perhaps transfer the content to a home game system. Thus, the user can play a game application on the home game system using content downloaded from game kiosk system 100.

For example, game kiosk system 100 may provide a user with the ability to choose from a variety of visual elements (e.g., the color of a race car) in a game application or to acquire various functional elements (e.g., a key to a race car) for use in the game application. The user may download the visual and/or functional elements to a portable memory device via memory interface 140. At home, the user may upload the elements from the portable memory device to a home game system. The user then may be able to change the color of the car and/or gain access to the car in a game application that is executing on the home game system using the elements downloaded from retail game kiosk system 100.

Game kiosk system 100 may provide a user with the ability to choose from a variety of audio elements (e.g., a sound and/or soundtrack) in a game application. The user may download the audio elements to a portable memory device via memory interface 140. At home, the user may upload the elements from the portable memory device to a home game system. The user then may be able to change the sounds and/or soundtrack in the game application that is executing on the home game system using the elements downloaded from retail game kiosk system 100.

Game kiosk system 100 may allow a user to download game data (e.g., a level of play, character information, scenes, etc.) after playing a game application on the system. The user may download the game data to a portable memory device via memory interface 140. At home, the user can upload the game data to a home game system. Once uploaded, the user has the capability to resume playing the game application on the home game system without losing any game data acquired on retail game kiosk system 100.

Game kiosk system 100 also may allow a user to personalize a user interface display on a home system by providing various images for the user interface. The user can download the images to a portable memory device via memory interface 140. At home, the user may upload the images from the portable memory device to the home game system. Once uploaded, the user has the capability to personalize the user interface display on the home system using one of the images downloaded from retail game kiosk system 100.

Game kiosk system 100 may permit a user to earn points, such as achievement points and/or Microsoft (MS) points, and download the points to a portable memory device via memory interface 140. The points may then be uploaded to a home game system. Achievement points may be awarded if a user accomplishes a certain task and/or achieves a certain score. Achievement points typically serve as an indicator of the user's skill level. MS points may be awarded to any user of game kiosk system 100 and can be used to purchase items made available to the home system via services such as Xbox® Live.

Game kiosk system 100 may also include software keys for accessing services such as Xbox® Live. The user can download the software key to a portable memory device via memory interface 140. At home, the user may upload the software from the portable memory device to the home game system. Once uploaded, the user has the capability to access the service on the home system using the software key downloaded from retail game kiosk system 100. The software key may permit access to the service for a limited or an unlimited period of time.

In one embodiment, game kiosks system 100 may be placed in a retail location, such as an electronics store. Game kiosk system 100 may include a game application that is not available at any other retailer. A customer may enter the store with a portable memory device that may be compatible with memory interface 140. Memory interface 140 may be located such that it is publicly accessible to all customers who use game kiosk system 100. The customer may use input device 130 to access and/or play the game application. The user may also connect the portable memory device to memory interface 140 and download the game application onto the portable device. The user may then disconnect the portable memory device from memory interface 140 and take the portable memory device home. At home, the user may connect the portable memory device to a memory interface on a home game system and upload the game application. Once the game application is uploaded, the user has the capability to play the game application on the home system.

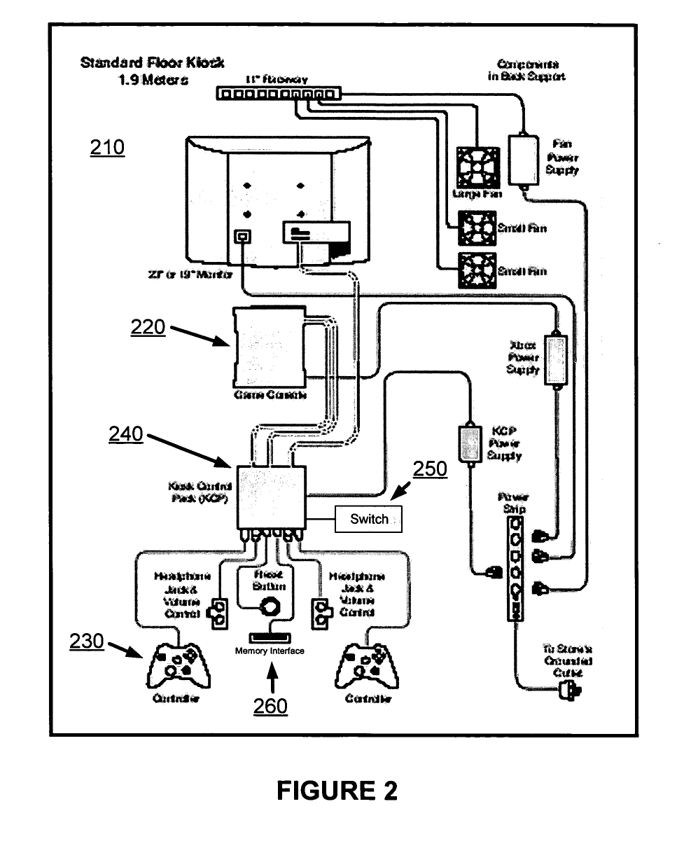

FIG. 2 is an illustration of an implementation of game kiosk system 200. Game kiosk system 200 includes, among other things, monitor 210, game console 220, controller 230, control pack 240, switch 250 and memory interface 260. Control pack 240 may provide control for, and function as, an interface between game console 220 and other portions of retail game kiosk system 200 such as monitor 210, controller 230 and switch 250. Control pack 240 may provide functions such as supplying power to game console 220, interfacing game console 220 to monitor 210 and interfacing game console 220 to memory interface 260. Control pack 240 may include a general purpose processor, a dedicated processor, hardware, software, or any combination thereof.

Game kiosk system 200 may be customized according to its operating location. A disc containing various game configurations may be inserted into a disc drive (not shown) that may be included in game console 220. A game configuration may include a game application, a game application feature (e.g., game data and visual, audio and functional elements associated with a game application), an image for a user interface display and/or software that is tailored to specific operating locations, such as a retailer. For example, a game configuration may include an Xbox® game application for racing cars, a game application feature for changing the color and/or sound of the car, software to provide text in a specific language (e.g., English, Spanish, French, Italian, German, Japanese, Korean, Portuguese and Traditional Chinese) and/or software to display retailer advertisements (e.g., logos).

Switch 250 may allow a specific game configuration to be selected. Once the game configuration is selected, it may be obtained from the disc via control pack 240. For example, a signal may be sent from switch 250 to control pack 240. Control pack 240 may receive and interpret the signal. When a disc is inserted into the disc drive of game console 220, kiosk software on the disc may load and query control pack 240. The directory on the disc may then be searched for the selected game configuration. Upon locating the selected game configuration on the disc, the game configuration may be loaded into the memory of game console 220. The game application may then be available for execution.

Other portions of the game configuration, such as advertisements and game application features, also may be available to game kiosk system 200. If the selected game configuration is not found, a default condition may be selected. The default condition may include any appropriate default condition, such as providing an error message, retrieving default game configuration, or a combination thereof. A default game configuration may exist in the game kiosk memory and may be available for execution. For example, a default game configuration may include an English generic game configuration.

The various techniques described herein may be implemented in connection with hardware, software, or a combination of both. Thus, the apparatus for a game kiosk system, or certain aspects or portions thereof, can take the form of program code (i.e., instructions) embodied in tangible media, such as floppy diskettes, CD-ROMs, hard drives, or any other machine-readable storage medium. When the program code is loaded into and executed by a machine, such as a computer, the machine becomes an apparatus for practicing gaming on a game kiosk system. In the case of program code execution on programmable computers, the computing device will generally include a processor, a storage medium readable by the processor (including volatile and non-volatile memory and/or storage elements), at least one input device, and at least one output device. The program(s) can be implemented in assembly or machine language, if desired. The language can be a compiled or interpreted language, and combined with hardware implementations.

While the present invention has been described in connection with the preferred embodiments of the various figures, it is to be understood that other similar embodiments may be used or modifications and additions may be made to the described embodiment for performing the same function of the present invention without deviating there from. For example, while exemplary embodiments of the invention are described in the context of a game console operating within a game kiosk system, one skilled in the art will recognize that the present invention is not limited to such an embodiment. For example, the present application may apply to any number of existing or emerging computing devices or environments, such as a personal computer, handheld computer, portable computer, etc., whether wired or wireless, and may be applied to any number of such computing devices connected via a communications network, and interacting across the network. Furthermore, it should be emphasized that a variety of computer platforms, including handheld device operating systems and other application specific operating systems, are herein contemplated, especially as the number of wireless networked devices continues to proliferate. Therefore, the present invention should not be limited to any single embodiment, but rather construed in breadth and scope in accordance with the appended claims.

What is claimed:

1. A computer terminal, comprising:
a processing device;
an input device; and
a publicly accessible memory interface that is adaptable to a portable memory device, wherein the portable memory device is capable of downloading game related content from the processing device.

2. The terminal of claim 1, wherein the processing device is in communication with a network.

3. The terminal of claim 2, wherein the processing device communicates with the network wirelessly.

4. The terminal of claim 1, wherein the input device comprises a game controller.

5. The terminal of claim 1, further comprising a display.

6. The terminal of claim 1, further comprising an audio output device.

7. The terminal of claim 1, wherein the game related content comprises at least one of the following: an image for a user interface display, a game application, game data, a visual element associated with a game application, an audio element associated with a game application and a functional element associated with a game application.

8. A system for downloading game related content, comprising:
a computer terminal comprising a processing device, an input device and a publicly accessible memory interface; and
a portable memory device that is adaptable to the memory interface, wherein the memory interface enables the portable memory device to download game related content from the terminal.

9. The system of claim 8, wherein the terminal is in communication with a network.

10. The system of claim 9, wherein the terminal communicates with the network wirelessly.

11. The system of claim 8, wherein the input device comprises a game controller.

12. The system of claim 8, wherein the terminal further comprises a display, an audio output device, or both.

13. The system of claim 8, wherein the game related content comprises at least one of the following: an image for a user interface display, a game application, game data, a visual element associated with a game application, an audio element associated with a game application and a functional element associated with a game application.

14. A computer terminal for accessing game related content, comprising:
a processing device;
an input device; and
a publicly accessible memory interface that is adaptable to a portable memory device, wherein the portable memory device is capable of downloading information from the processing device.

15. The terminal of claim 14, wherein the processing device is in communication with a network.

16. The terminal of claim 15, wherein the processing device communicates with the network wirelessly.

17. The terminal of claim 14, wherein the input device comprises a game controller.

18. The terminal of claim 14, further comprising a display, an audio output device, or both.

19. The terminal of claim 14, wherein the information comprises at least one of the following: audio-based content, video-based content, image-based content and game related content.

20. The terminal of claim 14, wherein a game kiosk system comprises the processing device, input device and publicly accessible memory interface.
